(19) United States
(12) Patent Application Publication
(10) Pub. No.: US 2017/0241402 A1
(43) Pub. Date: Aug. 24, 2017

(54) LARGE-SIZE WIND POWER BLADE HAVING MULTI-BEAM STRUCTURE AND MANUFACTURING METHOD THEREFOR

(71) Applicant: ZHUZHOU TIMES NEW MATERIALS TECHNOLOGY CO., LTD., Zhuzhou, Hunan (CN)

(72) Inventors: Xuebing FENG, Zhuzhou (CN); Chaoyi PENG, Zhuzhou (CN); Jingcheng ZENG, Zhuzhou (CN); Hang DENG, Zhuzhou (CN); Fubiao YANG, Zhuzhou (CN); Ziqian ZHANG, Zhuzhou (CN)

(73) Assignee: ZHUZHOU TIMES NEW MATERIALS TECHNOLOGY CO., LTD., Zhuzhou, Hunan (CN)

(21) Appl. No.: 15/519,297

(22) PCT Filed: Mar. 18, 2015
(86) PCT No.: PCT/CN2015/074497

§ 371 Date: Apr. 14, 2017

(30) Foreign Application Priority Data
Oct. 15, 2014 (CN) 2014105428735

(51) Int. Cl. F03D 1/06; B29C 70/22; B29C 70/44

(52) U.S. Cl. CPC F03D 1/0675; B29C 70/443; B29C 70/22; F05B 2240/30; F05B 2230/50; F05B 2250/70; F05B 2280/6003; B29K 2063/00

(57) ABSTRACT

A large-size wind power blade with a multi-beam structure and its manufacturing method, wherein the blade adopts a hollow layout structure and comprises a blade skin suction edge, a blade skin pressure edge, a main load-carrying structure crossbeam and anti-shearing webs, wherein the blade skin suction edge and the blade skin pressure edge are combined to form a cavity structure having a streamlined cross section, wherein a support structure formed by the combination of the main load-carrying structure crossbeam and the anti-shearing web is located in the cavity. Both the blade skin suction edge and the blade skin pressure edge adopt a multi-segment combined structure, wherein the multiple segments are connected to the side surface of the main load-carrying structure crossbeam to integrally form the blade skin suction edge and the skin pressure edge. Under the premise of ensuring the structural rigidity and strength, the anti-bending capability as well as the stability of the blade of the present invention is increased. With the use of high modulus carbon fiber laxer, the weight of the blade is reduced, the load of the blade, especially the fatigue load, is reduced is reduced.

### TECHNICAL FIELD

The current invention is related with components of a wind power equipment and its manufacture method, especially related with a large-size wind power blade with a multi-beam structure and an improved method for its manufacture.

### TECHNICAL BACKGROUND

It is well known that the wind power blades are becoming larger and larger. Even with the same output, the size of the blades is becoming larger and longer. With the change of the size of the blades, the blades are longer and softer. In order to meet the requirements of rigidity, strength and stability, it is necessary to add structure layers, especially to add structure layers close to the blade tip. This leads to an increase of the weight of the blade, and the weight center is more close to the blade tip, and the frequency is lower. In the meantime, with the increase of the weight, fatigue load will also increase, especially the increase of the fatigue load along the shimmy direction is very obvious.

In order to reduce the load of the blade, a most common way is to change the material of the main load-carrying structure of the blade, such as to use high strength, high modulus fiber to replace normal glass fibers, in order to reduce the weight of the blades and hence the load of the blade. However, structurally, the common layer method would lead to new problems. For example, when the width of the crossbeam of the blade does not change, and the commonly used glass fiber is replaced with carbon fiber, the thickness of the crossbeam is reduced and the stability of the blade structure is compromised. As a result, it is important to find a scientific and reasonable way to reduce the weight of the blade with the aerodynamic configuration unchanged, so that the frequency of the blade is increased, the fatigue load of the blade is reduced, which is of importance for the design and big sized, elongated blade structure.

The relevant state of the art is as follows:

1. The patent application, CN201010106039. 3, with the title “Multi-beam structure glass fiber reinforced plastic vierendeel vane of megawatt wind generator and producing method thereof”, discloses a multi-beam structure glass fiber reinforced plastic vierendeel vane of a megawatt wind generator, which comprises two blade shells, main beams fixed at the inner sides of the cane shells. The improvement is that: a plurality of ribs are distributed at intervals along the long direction of the blade shells. The ribs are in a ring shape; and the upper side surfaces and the lower side surfaces of the ribs are glued with the inner coating of the blade shells and the main beams to be fixed. Original total-stress blades are changed into small area stress by a vierendeel rib structure, torque force is strengthened by the vierendeel rib structure, and the blade strength is improved. Thus, foams do not need to filled, and the blade quality is largely reduced, so the vierendeel rib structure is constructed on a megawatt wind generator cane, the difficulty that the blade is made big and long is significantly reduced. The main beams of the blade and the blade shells are poured into a shape by an integrative way.

2. The Chinese patent application, CN201120483523.8, with the title of “a 2.0 MW carbon fiber wind turbine blades,” discloses a 2.0 MW carbon fiber wind turbine blades. The blade is made of glass fiber. In the middle of the blade shell, carbon fiber main beams and glass fiber secondary beams are placed on both sides. Between the carbon fiber main beam and the glass fiber secondary beams is filled with light wood, and the carbon fiber main beam as well as the glass fiber secondary beams form a duplex “ [symbol] ” structure using double shear web. Since the carbon fibers of the present invention provide sufficient strength, the problem of having too much and too thick glass fiber of conventional blade layer is overcome, and the amount of resin used has been reduced, which can reduce the weight of about 2000 Kg. In the meantime, the blade does not have pre-bending, which is more convenient for transportation, and improves aerodynamic efficiency. Cpmax maximum can reach 0.49, which increases output generated. In addition, due to the high stiffness of the blade, it is difficult for the blade to collide the tower during operation, and therefore more safe.

The Chinese patent application, CN201010532996.2, with the title “wind power blade”, discloses provides a wind driven generator blade. The wind driven generator blade is made of composite material, and the composite material comprises multiple fiber layers and a base material attached to the multiple fiber layers; and the fiber layers comprise carbon fibers and glass fibers, and the volume ratio of the carbon fibers to the glass fibers is 1:4-4:1. The fiber layers in the wind driven generator blade comprise at least two kinds of fibers, namely the carbon fibers and the glass fibers, wherein the carbon fibers have the advantages of high strength and light weight; and the glass fibers have the advantage of good toughness, and have good interface wetness with resin.

In the above patent applications, the multi-beam structure of the first patent application contains 2 beams, and the whole structure is not quite relevant to the present invention. In the blade structure of the second patent application, there are two main beams and two secondary beams, wherein the secondary beams are made of glass fiber cloth, which is different from the carbon fiber layer of all of the four main beams of the present invention. Although the third patent application mentions the use of carbon fiber, it is mixed with glass fiber, and the blade is made with the mixture. This does not change the safety of the whole structure and does not solve the stability issue of the blade structure. In addition, the production costs are increased, which is not good for its wide distribution. Therefore, it is important to reasonably take advantage of the characteristics of carbon fibers, and to increase the load carrying capability of the large size wind power blade and to ensure the stability of the structure at the same time, and to reasonably reduce the weight of the blade.

### CONTENT OF THE INVENTION

The technical problem to be solved by the present invention is to provide a large size and elongated wind power blade with reduced weight, increased blade frequency, reduced blade load and reduced production costs, as well as the manufacture method thereof.

The problem is solved by a large-size wind power blade with a multi-beam structure, wherein the blade adopts a hollow layout structure and comprises a blade skin suction edge, a blade skin pressure edge, a main load-carrying structure crossbeam and anti-shearing webs, wherein the blade skin suction edge and the blade skin pressure edge are combined to form a cavity structure having a streamlined cross section, wherein a support structure formed by the combination of the main load-carrying structure crossbeam and the anti-shearing web is located in the cavity, characterized in that both the blade skin suction edge and the blade skin pressure edge adopt a multi-segment combined structure, wherein the multiple segments are connected to the side surface of the main load-carrying structure crossbeam to integrally form the blade skin suction edge and the skin pressure edge.

Further, the main load-carrying structure cross beam is composed of four blade crossbeams, wherein the blade skin suction edge is provided with a first blade crossbeam and a second blade crossbeam, and the blade skin pressure edge is provided with a third blade crossbeam and a fourth blade crossbeam, and the four blade crossbeams are laterally connected with the blade skin suction edge and the blade skin pressure edge, so that the four blade crossbeams become part of the blade skin suction edge and the blade skin pressure edge.

Further, the connection between the four blade crossbeams and the blade skin suction edge as well as the blade skin pressure edge is cohesive connection, wherein the two sides of each of the four blade crossbeams are connected with the sides of the blade skin suction edge and the blade skin pressure edge respectively via uniform cross section and through resin adhesive.

Further, the multi-segment combined structure is that the blade skin suction edge and the blade skin pressure edge are divided into three segments respectively, which are the front sections of the blade skin suction edge and the blade skin pressure edge, the middle sections between the crossbeams, and the tail sections of the blade skin suction edge and the blade skin pressure edge.

Further, the sections between the crossbeams are provided with sandwich structure, wherein the thickness of the sandwich is optimum determined by stability calculation according to the blade load.

Further, the anti-shearing web plates are placed in the middle part of the blade crossbeam corresponding with the blade skin suction edge and the blade skin pressure edge, so that the four blade crossbeams form two “ [symbol] ” shaped supporting crossbeams.

Further, the tail sections of the blade skin suction edge and the blade skin pressure edge are provided with trailing edge force bearing structure trabeculae respectively, wherein the trailing edge force bearing structure trabeculae are connected with the middle segment of the tail sections of the blade skin suction edge and the blade skin pressure edge respectively to form part of the tail sections of the blade skin suction edge and the blade skin pressure edge.

Further, the trailing edge force bearing structure trabeculae are cohesively connected with the blade skin suction edge and the blade skin pressure edge, wherein the two sides of the trailing edge force bearing structure trabeculae are connected with the sides of the tail sections of the blade skin suction edge and the blade skin pressure edge via glue respectively.

Further, the four blade crossbeams and the trailing edge force bearing structure trabeculae are laid with carbon fiber layer and solidified, wherein the surface density of carbon fiber cloth is smaller than the surface density of the glass fiber cloth.

A method to manufacture the above described large-size wind power blade with a multi-beam structure, using multi-beam hollow structure to make the blades, providing a plurality of main load-carrying structure crossbeams in the blade skin suction edge and the blade skin pressure edge which are supported by the anti-shearing web, so that a wind power blade with cavity structure whose cross section is streamline is formed, characterized in that both the blade skin suction edge and the blade skin pressure edge adopt a multi-segment combined structure, wherein the blade skin suction edge and the blade skin pressure edge are divided into a plurality of segments and are manufactured separately, and the segments adhesively connected with the main load-carrying structure crossbeams from the side respectively, so that the blade skin suction edge and the blade skin pressure edge with multiple segments are formed.

Further, the main load-carrying structure cross beam is composed of four blade crossbeams, wherein the blade skin suction edge is provided with a first blade crossbeam and a second blade crossbeam, and the blade skin pressure edge is provided with a third blade crossbeam and a fourth blade crossbeam, and the tail sections of the blade skin suction edge and the blade skin pressure edge are provided with trailing edge force bearing structure trabeculae respectively, wherein the four blade crossbeams are laterally connected with the blade skin suction edge and the blade skin pressure edge, so that the four blade crossbeams become part of the blade skin suction edge and the blade skin pressure edge, and the four blade crossbeams are first manufactured and are cohesively connected with the anti-shearing web to form a “ [symbol] ” form crossbeam, the crossbeam is then placed in the positioning equipment and is laid and infused together with the blade skin suction edge and the blade skin pressure edge, and epoxy resin is used as infusion resin to realize solidification via vacuum infusion.

Further, the tail sections of the blade skin suction edge and the blade skin pressure edge are provided with trailing edge force bearing structure trabeculae respectively, wherein the trailing edge force bearing structure trabeculae are connected with the middle segment of the tail sections of the blade skin suction edge and the blade skin pressure edge respectively to form part of the tail sections of the blade skin suction edge and the blade skin pressure edge.

Further, the trailing edge force bearing structure trabeculae are cohesively connected with the blade skin suction edge and the blade skin pressure edge, wherein the two sides of the trailing edge force bearing structure trabeculae are connected with the sides of the tail sections of the blade skin suction edge and the blade skin pressure edge via glue respectively.

Further, the four blade crossbeams and the trailing edge force bearing structure trabeculae are laid with carbon fiber layer and solidified, wherein the surface density of carbon fiber cloth is smaller than the surface density of the glass fiber cloth, and epoxy resin is used as infusion resin to realize solidification via vacuum infusion.

In comparison with the state of the art, the advantages of the present invention are: the present invention provides a blade manufacture method as well as its structure, wherein the multi-segment skin is connected with the profiles of the blade crossbeams. In this way, the force bearing condition of the skin can be changed efficiently, the width of the crossbeam is reduced, and the layer thickness of the blade crossbeam is increased. According to the different force carrying condition, different skin for different segment is made. Sandwich structure is used in the section between crossbeams, in order to increase the stability of the whole blade structure. Under the premise of ensuring the structural rigidity and strength, the weight of the blade is reduced, the frequency of the blade is increases and the load of the blade is decreased. In addition, the problem of instability caused by the high strength and high modulus material is solved. The present invention is suitable for the manufacture of large size and elongated wind power blade, which significantly reduces the weight as well as the load of the blade.

### FIGURES

FIG. 1 shows the cross section of the blade of the present invention.

FIG. 2 shows the structure along the blade of the present invention (suction edge).

FIG. 3 shows the structure along the blade of the present invention (pressure edge).

### IN THE FIGURES

1. Suction edge close to the front edge crossbeam; 2. Suction edge close to the trailing edge crossbeam; 3. Suction edge close to trailing edge trabeculae; 4. Pressure edge close to front edge crossbeam; 5. Pressure edge close to trailing edge crossbeam; 6. Pressure edge close to trailing edge trabeculae; 7. Front edge web plate; 8. Trailing edge web plate; 9. Section between crossbeams of the suction edge; 10. Section between crossbeams of the pressure edge; 11. Blade skin suction edge; 12. Blade skin pressure edge.

### EMBODIMENTS

The present invention is further illustrated with the following figures and embodiments.

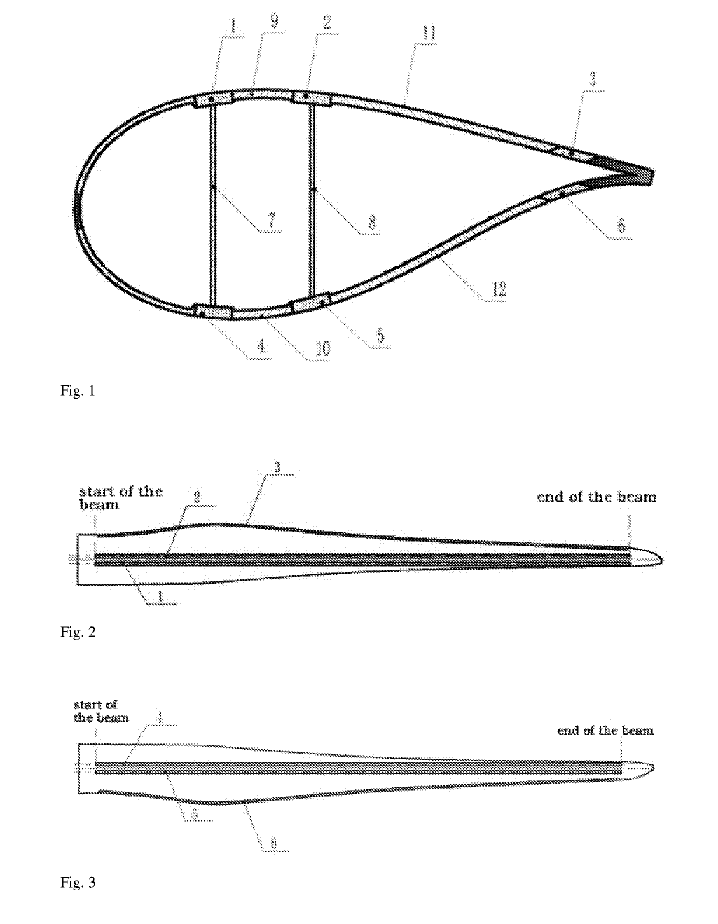

FIG. 1 shows the cross section of the blade of the present invention. FIG. 2 and FIG. 3 show the structure along the blade shell of the present invention.

A large-size wind power blade with a multi-beam structure, wherein the blade adopts a hollow layout structure and comprises a blade skin suction edge (11), a blade skin pressure edge (12), a main load-carrying structure crossbeam (1, 2, 4, 5) and anti-shearing web (7,8), trailing edge force bearing structure trabeculae (3, 6). The main load-carrying structure cross beam (1, 2, 4, 5) is composed of four blade crossbeams. The width of the blade structure crossbeam is 0.31 m, and the total length of the crossbeam is 52.51 m. The crossbeam is provided with one-way carbon fiber layer, namely 0° fiber is identical with the central line of the crossbeam. The surface density of the carbon fiber cloth is 600 g/m².

The sections 9 between the suction edge crossbeams and the sections 10 between the pressure edge crossbeams are provided with sandwich structure, wherein the width of the sandwich is 0.20 m. The sandwich is made of carbon fiber cloth and the thickness of the sandwich is optimum determined by stability calculation according to the blade load.

In the current embodiment, in order to reduce the weight of the blade, the four blade crossbeams of the blade skin suction edge and the blade skin pressure edge are laid with carbon fiber layer and solidified, wherein the surface density of carbon fiber cloth is smaller than the surface density of the glass fiber cloth. In a preferred embodiment, the surface density of the carbon fiber cloth is 600 g/m², and the surface density of the glass fiber cloth is 1215 g/m². Preferably, epoxy resin is used as infusion resin to realize solidification via vacuum infusion.

In comparison with the usage of sole glass fiber cloth in state of the art, the present invention replaces the glass fiber of the crossbeams with the carbon fiber cloth which has a smaller surface density, so that the weight of the blade is reduced significantly.

In the present invention, the blade crossbeams are first manufactured. The anti-shearing web plate is cohesively connected in the middle position of the inner surface of the blade structure crossbeam. The crossbeam is then placed in the positioning equipment. In the positioning equipment, the sandwich structure, the skin and the crossbeams are laid and infused together. The blade skin suction edge and the blade skin pressure edge form multi-segment combination structure, wherein the multiple segments are connected to the side surface of the main load-carrying structure crossbeam to integrally form the blade skin suction edge and the skin pressure edge, and are combined with the blade structure crossbeam and the anti-shearing web, so that a wind power blade with cavity structure whose cross section is streamline is formed.

With the same wind field level, the characteristics of the blade of the current invention is compared with the characteristics of the blade in the state of the art, as shown in FIG. 1. The suction edge crossbeam and the pressure edge crossbeam of the state of the art are both infused with glass fiber/epoxy resin.

| | | Blade of the |
|---|---|---|
| | Blade in state of the art | current invention |
| Blade length/m | 57.7 | 57.7 |
| Wind field level | IEC 3A | IEC 3A |
| Generated output | 3.0 MW | 3.0 MW |
| quantity/kg | 17443 | 13748 |
| Mass center/m | 17.40 | 15.50 |
| One order flap/Hz | 0.56 | 0.67 |
| One order lag motion/Hz | 0.98 | 1.17 |
| Blade root limit load/KNm | 16730 | 15408 |
| Blade root fatigue load/ | 7498 | 6591 |
| KNm | | |

As shown in FIG. 1, the one order flag and the one order lag motion of the blade of the present invention are significantly bigger than those of the blade of the state of the art. In addition, the blade root limit load and blade root fatigue load of the blade of the present invention are lower than those of the blade of the state of the art. This means that the load produced by the blade of the current invention is very small, which improves the safety of the whole machine.

From the above examples, the current invention is related with a method to manufacture the large-size wind power blade with a multi-beam structure as well as the wind power blade, using multi-beam hollow structure to make the blades, providing a plurality of main load-carrying structure crossbeams in the blade skin suction edge and the blade skin pressure edge which are supported by the anti-shearing web, so that a wind power blade with cavity structure whose cross section is streamline is formed, characterized in that both the blade skin suction edge and the blade skin pressure edge adopt a multi-segment combined structure, wherein the blade skin suction edge and the blade skin pressure edge are divided into a plurality of segments and are manufactured separately, and the segments adhesively connected with the main load-carrying structure crossbeams from the side respectively, so that the blade skin suction edge and the blade skin pressure edge with multiple segments are formed.

Further, the main load-carrying structure cross beam is composed of four blade crossbeams, wherein the blade skin suction edge is provided with a first blade crossbeam and a second blade crossbeam, and the blade skin pressure edge is provided with a third blade crossbeam and a fourth blade crossbeam, and the tail sections of the blade skin suction edge and the blade skin pressure edge are provided with trailing edge force bearing structure trabeculae respectively, wherein the four blade crossbeams are laterally connected with the blade skin suction edge and the blade skin pressure edge, so that the four blade crossbeams become part of the blade skin suction edge and the blade skin pressure edge, and the four blade crossbeams are first manufactured and are cohesively connected with the anti-shearing web to form a “ [symbol] ” form crossbeam, the crossbeam is then placed in the positioning equipment and is laid and infused together with the blade skin suction edge and the blade skin pressure edge, and epoxy resin is used as infusion resin to realize solidification via vacuum infusion.

Further, the tail sections of the blade skin suction edge and the blade skin pressure edge are provided with trailing edge force bearing structure trabeculae respectively, wherein the trailing edge force bearing structure trabeculae are connected with the middle segment of the tail sections of the blade skin suction edge and the blade skin pressure edge respectively to form part of the tail sections of the blade skin suction edge and the blade skin pressure edge.

Further, the trailing edge force bearing structure trabeculae are cohesively connected with the blade skin suction edge and the blade skin pressure edge, wherein the two sides of the trailing edge force bearing structure trabeculae are connected with the sides of the tail sections of the blade skin suction edge and the blade skin pressure edge via glue respectively.

Further, the four blade crossbeams and the trailing edge force bearing structure trabeculae are laid with carbon fiber layer and solidified, wherein the surface density of carbon fiber cloth is smaller than the surface density of the glass fiber cloth, and epoxy resin is used as infusion resin to realize solidification via vacuum infusion.

A large-size wind power blade with a multi-beam structure, wherein the blade adopts a hollow layout structure and comprises a blade skin suction edge, a blade skin pressure edge, a main load-carrying structure crossbeam and an anti-shearing web, wherein the blade skin suction edge and the blade skin pressure edge are combined to form a cavity structure having a streamlined cross section, wherein a support structure formed by the combination of the main load-carrying structure crossbeam and the anti-shearing web is located in the cavity, characterized in that both the blade skin suction edge and the blade skin pressure edge adopt a multi-segment combined structure, wherein the multiple segments are connected to the side surface of the main load-carrying structure crossbeam to integrally form the blade skin suction edge and the skin pressure edge.

Further, the main load-carrying structure cross beam is composed of four blade crossbeams, wherein the blade skin suction edge is provided with a first blade crossbeam and a second blade crossbeam, and the blade skin pressure edge is provided with a third blade crossbeam and a fourth blade crossbeam, and the four blade crossbeams are laterally connected with the blade skin suction edge and the blade skin pressure edge, so that the four blade crossbeams become part of the blade skin suction edge and the blade skin pressure edge.

Further, the connection between the four blade crossbeams and the blade skin suction edge as well as the blade skin pressure edge is cohesive connection, wherein the two sides of each of the four blade crossbeams are connected with the sides of the blade skin suction edge and the blade skin pressure edge respectively via uniform cross section and through resin adhesive. That is to say, the profiles of the blade skin suction edge and the blade skin pressure edge close to the blade crossbeams are the same as the profiles of the blade crossbeams, and form a bell mouth shaped opening of the blade skin suction edge and the blade skin pressure edge, in order to ensure a stable cohesive connection between the blade crossbeam and the blade skin suction edge as well as the blade skin pressure edge.

Further, the multi-segment combined structure is that the blade skin suction edge and the blade skin pressure edge are divided into three segments respectively, which are the front sections of the blade skin suction edge and the blade skin pressure edge, the middle sections between the crossbeams, and the tail sections of the blade skin suction edge and the blade skin pressure edge.

Further, the sections between the crossbeams are provided with sandwich structure, wherein the thickness of the sandwich is optimum determined by stability calculation according to the blade load.

Further, the anti-shearing web plates are placed in the middle part of the blade crossbeam corresponding with the blade skin suction edge and the blade skin pressure edge, so that the four blade crossbeams form two “ [symbol] ” shaped supporting crossbeams.

The tail sections of the blade skin suction edge and the blade skin pressure edge are provided with trailing edge force bearing structure trabeculae respectively, wherein the trailing edge force bearing structure trabeculae are connected with the middle segment of the tail sections of the blade skin suction edge and the blade skin pressure edge respectively to form part of the tail sections of the blade skin suction edge and the blade skin pressure edge.

The large-size wind power blade with a multi-beam structure according to claim 5, characterized in that the trailing edge force bearing structure trabeculae are cohesively connected with the blade skin suction edge and the blade skin pressure edge, wherein the two sides of the trailing edge force bearing structure trabeculae are connected with the sides of the tail sections of the blade skin suction edge and the blade skin pressure edge via glue respectively.

Further, the four blade crossbeams and the trailing edge force bearing structure trabeculae are laid with carbon fiber layer and solidified, wherein the surface density of carbon fiber cloth is smaller than the surface density of the glass fiber cloth.

In comparison with the state of the art, the advantages of the present invention are: the present invention provides a blade manufacture method as well as its structure, wherein the multi-segment skin is connected with the profiles of the blade crossbeams. In this way, the force bearing condition of the skin can be changed efficiently, the width of the crossbeam is reduced, and the layer thickness of the blade crossbeam is increased. According to the different force carrying condition, different skin for different segment is made. Sandwich structure is used in the section between crossbeams, in order to increase the stability of the whole blade structure. Under the premise of ensuring the structural rigidity and strength, the weight of the blade is reduced, the frequency of the blade is increases and the load of the blade is decreased. In addition, the problem of instability caused by the high strength and high modulus material is solved. The present invention is suitable for the manufacture of large size and elongated wind power blade, which significantly reduces the weight as well as the load of the blade.

1. A large-size wind power blade with a multi-beam structure, wherein the blade adopts a hollow layout structure and comprises a blade skin suction edge, a blade skin pressure edge, a main load-carrying structure crossbeam and anti-shearing webs, wherein the blade skin suction edge and the blade skin pressure edge are combined to form a cavity structure having a streamlined cross section, wherein a support structure formed by the combination of the main load-carrying structure crossbeam and the anti-shearing web is located in the cavity, characterized in that both the blade skin suction edge and the blade skin pressure edge adopt a multi-segment combined structure, wherein the multiple segments are connected to the side surface of the main load-carrying structure crossbeam to integrally form the blade skin suction edge and the skin pressure edge.

2. The large-size wind power blade with a multi-beam structure according to claim 1, characterized in that the main load-carrying structure cross beam is composed of four blade crossbeams, wherein the blade skin suction edge is provided with a first blade crossbeam and a second blade crossbeam, and the blade skin pressure edge is provided with a third blade crossbeam and a fourth blade crossbeam, and the four blade crossbeams are laterally connected with the blade skin suction edge and the blade skin pressure edge, so that the four blade crossbeams become part of the blade skin suction edge and the blade skin pressure edge.

3. The large-size wind power blade with a multi-beam structure according to claim 2, characterized in that the connection between the four blade crossbeams and the blade skin suction edge as well as the blade skin pressure edge is cohesive connection, wherein the two sides of each of the four blade crossbeams are connected with the sides of the blade skin suction edge and the blade skin pressure edge respectively via uniform cross section and through resin adhesive.

4. The large-size wind power blade with a multi-beam structure according to claim 3, characterized in that the multi-segment combined structure is that the blade skin suction edge and the blade skin pressure edge are divided into three segments respectively, which are the front sections of the blade skin suction edge and the blade skin pressure edge, the middle sections between the crossbeams, and the tail sections of the blade skin suction edge and the blade skin pressure edge.

5. The large-size wind power blade with a multi-beam structure according to claim 1, characterized in that the tail sections of the blade skin suction edge and the blade skin pressure edge are provided with trailing edge force bearing structure trabeculae respectively, wherein the trailing edge force bearing structure trabeculae are connected with the middle segment of the tail sections of the blade skin suction edge and the blade skin pressure edge respectively to form part of the tail sections of the blade skin suction edge and the blade skin pressure edge.

6. The large-size wind power blade with a multi-beam structure according to claim 5, characterized in that the trailing edge force bearing structure trabeculae are cohesively connected with the blade skin suction edge and the blade skin pressure edge, wherein the two sides of the trailing edge force bearing structure trabeculae are connected with the sides of the tail sections of the blade skin suction edge and the blade skin pressure edge via glue respectively.

7. A method to manufacture the large-size wind power blade with a multi-beam structure according to claim 1, using multi-beam hollow structure to make the blades, providing a plurality of main load-carrying structure crossbeams in the blade skin suction edge and the blade skin pressure edge which are supported by the anti-shearing web, so that a wind power blade with cavity structure whose cross section is streamline is formed, characterized in that both the blade skin suction edge and the blade skin pressure edge adopt a multi-segment combined structure, wherein the blade skin suction edge and the blade skin pressure edge are divided into a plurality of segments and are manufactured separately, and the segments adhesively connected with the main load-carrying structure crossbeams from the side respectively, so that the blade skin suction edge and the blade skin pressure edge with multiple segments are formed.

8. The method to manufacture the large-size wind power blade with a multi-beam structure according to claim 7, characterized in that the main load-carrying structure cross beam is composed of four blade crossbeams, wherein the blade skin suction edge is provided with a first blade crossbeam and a second blade crossbeam, and the blade skin pressure edge is provided with a third blade crossbeam and a fourth blade crossbeam, and the tail sections of the blade skin suction edge and the blade skin pressure edge are provided with trailing edge force bearing structure trabeculae respectively, wherein the four blade crossbeams are laterally connected with the blade skin suction edge and the blade skin pressure edge, so that the four blade crossbeams become part of the blade skin suction edge and the blade skin pressure edge, and the four blade crossbeams are first manufactured and are cohesively connected with the anti-shearing web to form a “ [symbol] ” form crossbeam, the crossbeam is then placed in the positioning equipment and is laid and infused together with the blade skin suction edge and the blade skin pressure edge, and epoxy resin is used as infusion resin to realize solidification via vacuum infusion.

9. The method to manufacture the large-size wind power blade with a multi-beam structure according to claim 8, characterized in that the tail sections of the blade skin suction edge and the blade skin pressure edge are provided with trailing edge force bearing structure trabeculae respectively, wherein the trailing edge force bearing structure trabeculae are connected with the middle segment of the tail sections of the blade skin suction edge and the blade skin pressure edge respectively to form part of the tail sections of the blade skin suction edge and the blade skin pressure edge.

10. The method to manufacture the large-size wind power blade with a multi-beam structure according to claim 6, characterized in that the four blade crossbeams and the trailing edge force bearing structure trabeculae are laid with carbon fiber layer and solidified, wherein the surface density of carbon fiber cloth is smaller than the surface density of the glass fiber cloth, and epoxy resin is used as infusion resin to realize solidification via vacuum infusion.
